(19) United States
(12) Patent Application Publication
(10) Pub. No.: US 2009/0006090 A1
(43) Pub. Date: Jan. 1, 2009

(54) IMAGE COMMUNICATION APPARATUS AND CONTROL METHOD OF THE SAME

(75) Inventor: Kyoung-wook KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/051,409

(22) Filed: Mar. 19, 2008

(30) Foreign Application Priority Data
Jun. 29, 2007 (KR) 10-2007-0065204

(51) Int. Cl. G10L 15/26; G06F 17/30; G10L 13/00; G06F 3/00

(52) U.S. Cl. 704/235; 704/260; 707/101; 715/716; 707/E17.006; 704/E15.043

(57) ABSTRACT

An image communication apparatus includes: an image pickup unit which picks up a user image of a user and processes the user image into a user image signal; an audio input unit which receives a user audio signal of the user; an encoder which encodes the user image signal processed by the image pickup unit and the user audio signal; a communication unit which receives an encoded image signal and an encoded audio signal from outside and transmits the user image signal and the user audio signal which are encoded by the encoder; a decoder which decodes the encoded image signal and the encoded audio signal which are received through the communication unit; and a controller which converts at least one of the user audio signal, the user image signal, the decoded image signal and the decoded audio signal into a data file which is stored.

### CROSS-REFERENCE TO RELATED APPLICATIONS

This application claims priority from Korean Patent Application No. 10-2007-0065204, filed on Jun. 29, 2007 in the Korean Intellectual Property Office, the disclosure of which is incorporated herein by reference.

### BACKGROUND OF INVENTION

1. Field of Invention

Apparatuses and methods consistent with the present invention relate to an image communication apparatus and a control method of the same, more particularly, to an image communication apparatus which stores contents of communications and a control method of the same.

2. Description of the Related Art

A number of image communication solutions have been introduced along with high-speed internet lines. Software such as SkyPe has provided image telephony over the whole world for an inexpensive price. In addition, image communication systems are being developed to be employed even in vehicles.

When using an image communication system, a user may want to store contents in communications as necessary. In this case, an appropriate environment is required to store contents of communications in a variety of formats.

### SUMMARY OF THE INVENTION

The present invention provides an image communication apparatus which is capable of storing contents of communications as various kinds of formats, such as an audio format, a text format and/or an image format, and a control method of the same.

The present invention also provides an image communication apparatus which is capable of storing information on motion of an object as an audio format or a text format as well as contents of communications and a control method of the same.

The present invention also provides an image communication apparatus which provides various kinds of user interfaces so that a user may select a format to store contents of communications by and a control method of the same.

According to an aspect of the present invention, there is provided an image communication apparatus including: a display which displays an image signal; an image pickup unit which picks up a user image of a user and processes the user image into a user image signal; an audio input unit which receives a user audio signal of the user; an encoder which encodes the user image signal processed by the image pickup unit and the user audio signal; a communication unit which receives an encoded image signal and an encoded audio signal from outside and transmits the user image signal and the user audio signal which are encoded by the encoder; a decoder which decodes the encoded image signal and the encoded audio signal which are received through the communication unit; a storage unit; and a controller which converts at least one of the user audio signal, the user image signal, the decoded image signal and the decoded audio signal into a data file and stores the data file in the storage unit.

The image communication apparatus may further include a user input unit which is provided to select a function of storing a data; and a user interface generating unit which generates user interface information to be displayed on the display, wherein the controller controls the user interface generating unit to display a first menu window, where a data format to store the data file is selected, on the display if the function of storing the data is selected through the user input unit.

The data format may include at least one of an audio compression format, an image compression format and a text format.

The first menu window may include an item to select at least one of the audio compression format, the image compression format and the text format as the data format.

The controller may include an audio-text conversion unit which converts at least one of the user audio signal and the decoded audio signal into the text format.

The image communication apparatus may further include a text-audio conversion unit which converts the text format into an audio signal.

The image communication apparatus may further include an audio output unit which outputs the user audio signal and the decoded audio signal.

The controller may control the user interface generating unit to display a second menu window which includes an item to select a format of playing the data file on the display if a command to play the data file is input through the user input unit, and controls the storage unit and the text-audio conversion unit to output the data file to one of the audio output unit and the display according to the format of playing the data file.

According to another aspect of the present invention, there is provided a control method of an image communication apparatus including: processing a user image of a user which is picked up, into a user image signal; encoding the processed user image signal and a user audio signal of the user; transmitting the encoded user image signal and the encoded user audio signal to outside; receiving an encoded image signal and an encoded audio signal from outside; decoding the encoded image signal and the encoded audio signal received from the outside; and performing a data storage function which includes converting at least one of the user image signal, the user audio signal, the decoded image signal and the decoded audio signal into a data file and storing the data file.

The control method may further include receiving a selection signal to select the data storage function; and generating and displaying a first menu window where a data format to store the data file is selected.

The first menu window may include an item to select at least one of an audio compression format, an image compression format and a text format as the data format.

The performing the data storage function may include converting the user audio signal and the decoded audio signal into the text format if the text format is selected.

The control method may further include receiving a command to play the data file; generating and displaying a second menu window which includes an item to select a format of playing the data file; and playing the data file in an audio signal and an image signal according to the format of the playing the data file.

The second menu window may include an item to select at least one of an audio format, an image format and the text format as the format of the playing.

The playing may include converting the data file stored in the text format into an audio signal if the audio format is selected.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a control block diagram of an image communication apparatus according to a first exemplary embodiment of the present invention;

FIG. 2 is a control block diagram of an image communication apparatus according to a second exemplary embodiment of the present invention;

FIG. 3 illustrates a menu window for an agreement on storing a data file in the image communication apparatus according to the second exemplary embodiment of the present invention;

FIG. 4 illustrates a menu window for storing a data file in the image communication apparatus according to the second exemplary embodiment of the present invention;

FIG. 5 is a flow chart to illustrate a method of storing an audio signal in the image communication apparatus according to the second exemplary embodiment of the present invention;

FIG. 6 is another control block diagram of the image communication apparatus according to the second exemplary embodiment of the present invention;

FIG. 7 illustrates a menu window for playing a data file in the image communication apparatus according to the second exemplary embodiment of the present invention;

FIG. 8 is a flow chart to illustrate a method of playing an audio signal in the image communication apparatus according to the second exemplary embodiment of the present invention;

FIG. 9 illustrates a menu window for storing information on an object in an image communication apparatus according to a third exemplary embodiment of the present invention;

FIG. 10 is a flow chart to illustrate a method of storing information on an object in the image communication apparatus according to the third exemplary embodiment of the present invention; and

FIG. 11 is a flow chart to illustrate a control method of the image communication apparatus according to an exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures.

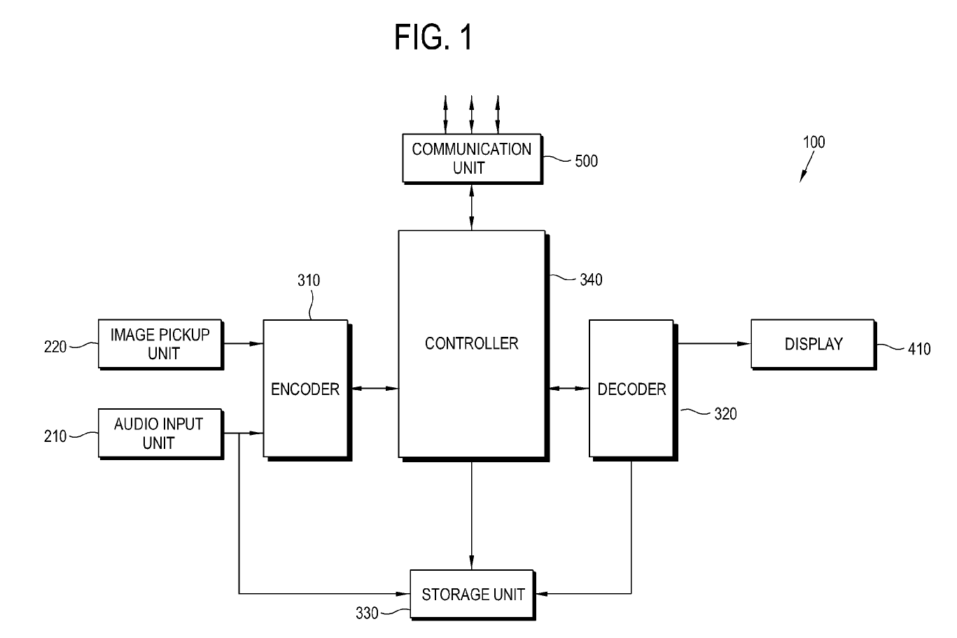

Referring to FIG. 1, an image communication apparatus 100 according to a first exemplary embodiment of the present invention includes an audio input unit 210, an image pickup unit 220, an encoder 310, a decoder 320, a storage unit 330, a display 410, a communication unit 500 and a controller 340 which controls the foregoing components.

The audio input unit 210 is provided to input an audio signal of a user, or a user audio signal. That is, when a user communicates with a counterpart looking at a screen during image communication, the user and the counterpart input their voices. Generally, the audio input unit 210 may be provided as a microphone.

The image pickup unit 220 picks up an image of a user, or a user image and processes it into a user image signal. The image pickup unit 220 includes a camera as an image pickup component which picks up an image signal and an image signal processor (ISP) which processes the image signal picked up by the image pickup component. The picked up image signal is displayed on the display 410 or transmitted to the outside via the communication unit 500.

The encoder 310 encodes the image signal of the user processed by the image pickup unit 220 and the audio signal of the user input through the audio input unit 210. The user image signal and the user audio signal encoded in the encoder 310 are transmitted through the communication unit 500 to the outside and input to a communication unit (not shown) for the counterpart or decoded in the decoder 320. Here, the encoder 310 encodes an image signal using an algorithm to compress moving pictures, e.g., Moving Picture Experts Groups-4 (MPEG-4).

The decoder 320 decodes an encoded image signal and audio signal which are input from the outside or a user signal which is input via the image pickup unit 220 and the audio input unit 210 and encoded by the encoder 310. The decoder 320 is basically set up to decode a signal input from the outside. However, the user may display his/her picture and the counterpart's picture on one screen and watch them at the same time as necessary.

The communication unit 500 receives an image signal and an audio signal which are encoded via a predetermined communication process, or transmits a user image signal and a user audio signal, which are input to the image communication apparatus 100 and encoded in the encoder 310, to the outside. The communication unit 500 may be provided as a communication network which includes an internet host or an Ethernet host, or as a person to person communication system. Further, the communication unit 500 may include a wired/wireless communication system. In the present exemplary embodiment, the image communication apparatus may convert an audio signal into the Internet protocol data packet by employing a voice over Internet protocol (VoIP) which uses a packet network for data communication and transmits it to the outside.

The display 410 displays an image signal decoded by the decoder 320 and a data file stored in the storage unit 330 as an image format or a text format. The display 410 may include one of a cathode ray tube (CRT), a liquid crystal display (LCD), a plasma display panel (PDP), etc. Here, if the display 410 is provided as an LCD, a scaling unit which is input with an image signal decoded by the decoder 320 and adjusts the size of an image to be output to the display 410 may be further provided between the decoder 320 and the display 410.

The storage unit 330 stores data files of an audio signal and an image signal which are input from the audio input unit 210, the image pickup unit 220 or the communication unit 500 according to a control by the controller 340. The data files are classified into one of an audio compression format, an image compression format and a text format.

The controller 340 converts at least one of an audio signal of a user, an image signal of the user, a decoded image signal and a decoded audio signal into a data file and stores the data file in the storage unit 330 if an event meeting a predetermined condition occurs, i.e., an event to store an audio signal or an image signal. The data file may be one of an audio compression format, an image compression format and a text compression format. The audio compression format is a format to compress an audio signal, the image compression format is a format by an algorithm to compress moving pictures supported by the encoder 310, and the text format is a form of letters which a user can visually recognize. The text format may be expressed in various languages such as Korean, English, Japanese, etc., as a symbol to output raised letter for a visually handicapped person, or as an encoded symbolic mark. An audio signal is stored in an audio compression format or a text format, and an image signal is stored as an image compression signal.

The condition for the controller 340 to store an audio signal or an image signal as a data file may be generated by a user's setup or may be preset by default. For example, if only a text format is required for the communication contents, it is set up to store an audio signal in a text format.

The controller 340 may store an audio or image signal of the user only, or an audio or image signal of the counterpart only which is received through the communication unit 500.

The present exemplary embodiment is described with the image communication apparatus 100 which stores an audio or image signal as a data file in the storage unit 330 as an example. However, the communication apparatus 100 is not limited to an image communication apparatus. Other communication apparatuses, e.g., a wire/wireless audio communication apparatus which is for audio communication only such as a telephone or a wireless set, may employ the controller 340 and the storage unit 330 according to the present exemplary embodiment as long as an audio signal is stored as a data format.

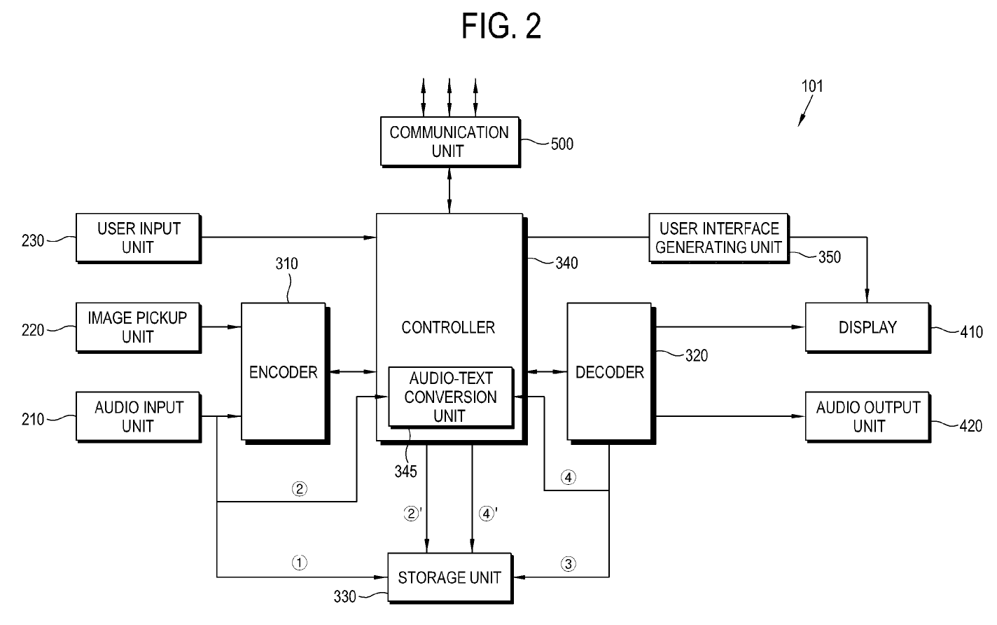

FIG. 2 is a control block diagram of an image communication apparatus according to a second exemplary embodiment of the present invention. Referring to FIG. 2, an image communication apparatus 101 according to the present exemplary embodiment further includes a user input unit 230, a user interface (UI) generating unit 350, an audio output unit 420, and a controller 340 includes an audio-text conversion unit 345. Components similar to those according to the foregoing exemplary embodiment will not repeatedly explained.

The user input unit 230 is provided for a user to select a function of storing a data. If audio and image signals are stored or played (or outputted), or if a control signal asking for whether to store a data is input from the outside, the user outputs a corresponding command to the controller 340 using the user input unit 230. The user input unit 230 may include an input apparatus such as a shortcut button, a touch pad, a keyboard, a mouse and the like, or a remote controller which may control the image communication apparatus 101 from a distance. The input apparatus may be provided on the outside of a housing of a display apparatus. The user input unit 230 includes a signal processing unit (not shown) which receives and processes a command input via the described input apparatuses and outputs the command to the controller 340.

The user interface generating unit 350 generates a variety of user interface information to be displayed on the display 410 according to a control by the controller 340. A variety of menu windows displayed on the display 410 as user interface information will be explained later.

The audio output unit 420 outputs an audio signal of the user, an audio signal decoded by the decoder 320, and an audio signal in an audio compression format among the data file stored in the storage unit 330. The audio output unit 420 may include a component which decompresses a file compressed in an audio compression format, e.g., an amplifying circuit which amplifies an input audio signal and a speaker which outputs an amplified audio signal.

The audio-text conversion unit 345 converts an audio signal input from the audio input unit 210 or a communication unit 500 into a text format. That is, the audio-text conversion unit 345 converts an audio signal in an audio format which produces a sound into a text format. Referring to FIG. 2, the audio-text conversion unit 345 is provided in the controller 340. However, the audio-text conversion unit 345 may be provided as a form of a separate chip which is controlled externally, or may be provided in a controller which entirely controls a display apparatus and performs as the audio-text conversion unit 345.

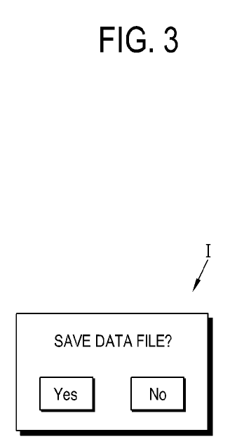

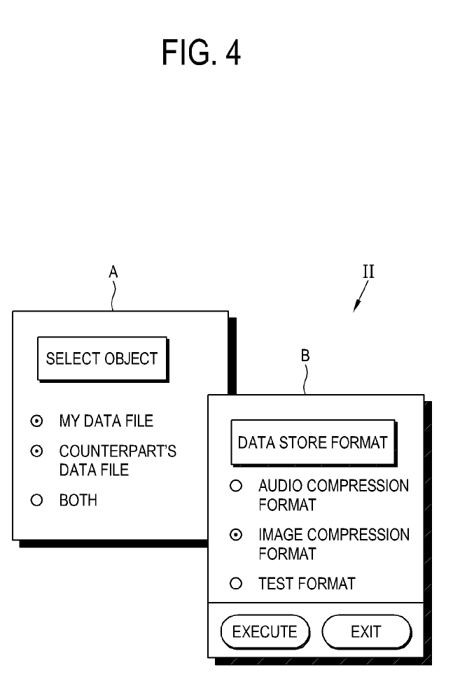

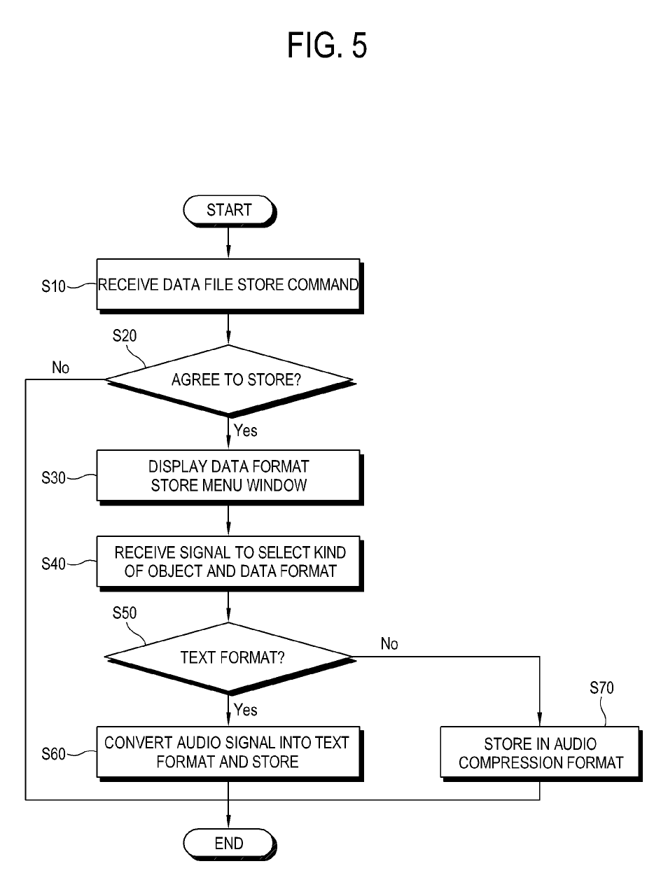

FIG. 3 illustrates a menu window (I) for obtaining an agreement on storing a data file in the image communication apparatus 101 according to the present exemplary embodiment; FIG. 4 illustrates a menu window (II) for storing a data file in the image communication apparatus 101 according to the present exemplary embodiment; and FIG. 5 is a flow chart to illustrate a method of storing an audio signal in the image communication apparatus 101 according to the present exemplary embodiment. Hereinafter, a method of storing a data file according to the controller 340 will be described with reference to FIGS. 3 through 5.

If a control signal to request a consent on storing a data file from a counterpart is input during image communication, the controller 340 controls the user interface generating unit 350 to display, on the display 400, a menu window (I) on which the user may select whether to store the data file, as shown in FIG. 3. As storing contents in communications is directly related to one's privacy and stored contents may be leaked out, two counterparts in communications need to agree on storing contents in communications. The user selects a “YES” icon to agree to storing the data file and a “NO” icon to disagree to storing the data file. If the user selects a “YES” icon, the data file is stored.

If the user wants to store the data file, a command to store the data file is output to the controller 340 via the user input unit 230 and a control signal requesting agreement of the counterpart is transmitted to the counterpart via communication unit 500.

If the data file is stored under mutual agreement, the user interface generating unit 350 displays a menu window (II) for storing a data file on the display 410, as shown in FIG. 4. The menu window (II) includes a first menu window (A) to select one object that the user wants to store and a second menu window (B) which is formed as a sub-window when one of items is selected from the first menu window (A).

The first menu window (A) includes items to select the user's data file, a counterpart's data file and both data files. The user may select one or more of the items. If the item is selected, a selection mark (•) is marked on the left side of the selected item and the selected item is activated to form a second menu window (B).

The second menu window (B) includes items to select an audio compression format, an image compression format or a text format, and an “execute” icon to store a data file as a desired format and an “exit” icon to close the second menu window. If an item is selected, a selection mark (•) is marked on the left side of the selected item. The user may select an object to be stored and a data format of a data file individually using the first menu window (A) and the second menu window (B).

The controller 340 compresses and stores an audio signal of the user or a decoded audio signal, if an audio compression format is selected. The controller 340 stores a user picked up image signal or the user counterpart image signal received through the communication unit 500 if an image compression format is selected.

If a text format is selected, the controller 340 inputs an audio signal of a user or a decoded audio signal to the audio-text conversion unit 345 to be converted into a text format and stores the audio signal in the text format in the storage unit 330. As shown in FIG. 2, an audio signal of a user input to the audio input unit 210 is stored as an audio compression format (path \textcircled{1}), or input to the audio-text conversion unit 345 (path \textcircled{2}) for conversion into a text format to be stored as a text file in the storage unit 330 (path \textcircled{2}′). An audio signal input via the communication unit 500 is decoded in the decoder 320, and then stored as an audio compression format (path \textcircled{3}), or input to the audio-text conversion unit 345 (path \textcircled{4}) for conversion into a text format to be stored as a text file in the storage unit 500 (path \textcircled{4}′).

Referring to FIG. 5, a method of storing a data file, which is an audio signal in particular, is summarized as follows. If a command to store a data file is received (S10), a control signal requesting an agreement on storing the data file is output and the menu window (I) to select the agreement on whether to store the data file is displayed on the display 410. If the user and the counterpart agrees on storing the data file (S20), the memo window (II) to store a data file is displayed (S30).

Then, a signal to select the kind of an object and a data format is received through the user input unit 230 (S40), and the controller 340 determines whether a selected data format is a text format (S50). If a text format is selected to store the data file, the audio signal is converted into the text format by the audio-text conversion unit 345 and stored in the storage unit 330 (S60). If an audio compression format is selected, the audio signal is stored as the audio compression format in the storage unit 330 (S70). However, if the user or the counterpart does not agree on storing the data file, the data file including the audio signal is not stored.

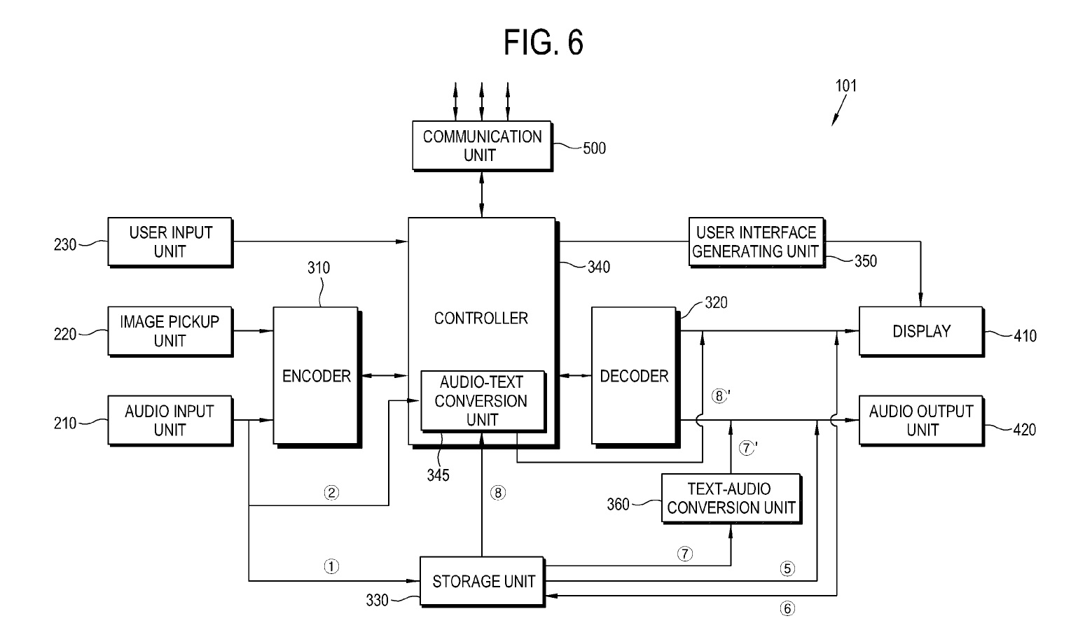

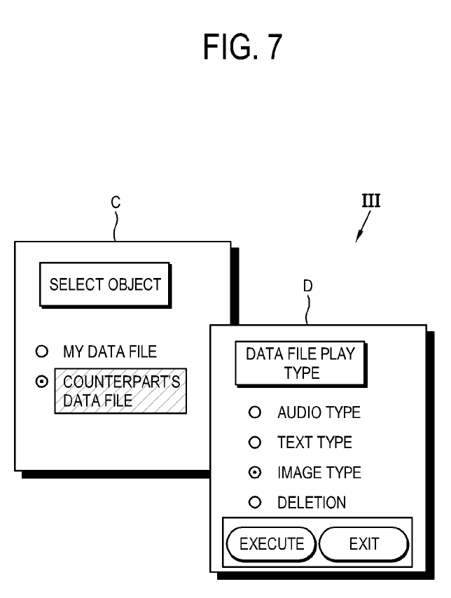

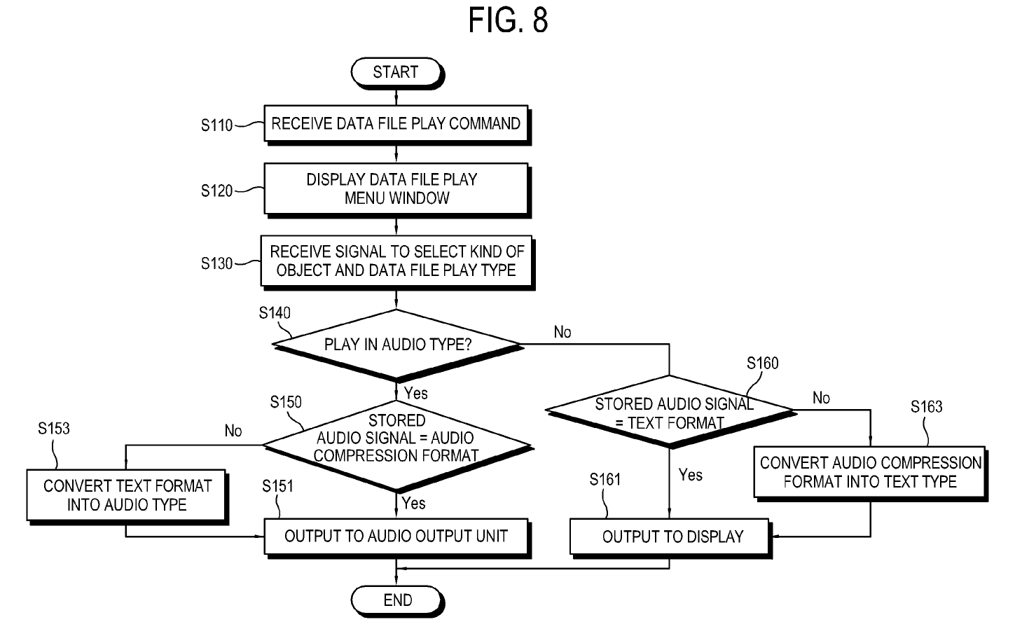

FIG. 6 is another control block diagram of the image communication apparatus 101 according to the second exemplary embodiment of the present invention which illustrates a method of playing a stored data file. FIG. 7 illustrates a menu window (III) for playing a data file; and FIG. 8 is a flow chart to illustrate a method of playing a data file. Hereinafter, a process of playing a data file in the image communication apparatus 101 according to the present exemplary embodiment will be described with reference to FIGS. 6 through 8.

Referring to FIG. 6, the image communication apparatus 101 further includes a text-audio conversion unit 360. The text-audio conversion unit 360 converts an audio signal stored in a text format into an audio type. The audio signal converted in the audio type by the text-audio conversion unit 360 is output through the audio output unit 420.

If a command to play or output a data file is received through the user input unit 230 (S110 in FIG. 8), the controller 340 displays a menu window (III) for playing a data file on the display 410 (S120), as shown in FIG. 7. The menu window (III) for playing a data file includes a third menu window (C) to select an object to be played and a fourth window (D) which is formed as a sub-window when one of items is selected.

The third menu window (III) includes the user's data file and a counterpart's data file as items for selection. Here, a data file stored corresponding to a command to store a data file is activated and may be displayed in bold characters to inform the user of its activating state. As illustrated in FIG. 7, “my data file” icon is not activated, while a “counterpart's data file” icon is activated. The user may select one or more of the activated items. If an item is selected, a selection mark (•) is marked on the left side of the selected item and a fourth menu window (D) is formed corresponding to the selected item.

The fourth menu window (D) includes items to select an audio type, an image type, a text type and delete, and an “execute” icon to play a data file in a selected play type and an “exit” icon to close the fourth menu window. If the item is selected, a selection mark (•) is marked on the left side of the selected item. The user may select an object to be played and a play type of a selected data file individually using the third menu window (C) and the fourth menu window (D). If the user selects a “delete” item, a data file is not played and a stored data file is deleted.

The controller 340 receives a signal to select an object to be played and a play type of a data file through the menu window (III) for playing the data file (S130) and plays the data file according to the selected play type. If an image type is selected, the data file stored in an image compression format is decompressed and displayed on the display 410.

Hereinafter, a method of playing an audio signal will be explained. To play or output the audio signal, the controller 340 determines whether a selected data file play type is an audio type (S140).

If the data file play type is determined to be the audio type, the controller 340 determines whether the audio signal is stored in an audio compression format (S150). If the stored audio signal is in the audio compression format, the audio signal is decompressed and output to the audio output unit 420 (S151).

However, if the audio signal is stored not in the audio compression format but in a text format, the audio signal is converted into the audio type (S153). That is, the controller 340 inputs the audio signal stored in the text format at the storage unit 330 to the text-audio conversion unit 360 in order to convert the audio signal of the text format into the audio type.

Then, the controller 340 outputs the converted audio signal in the audio type to the audio output unit 420, thereby playing the audio signal (S151).

If the controller 340 determines that the data file play type to play the audio signal is in the text type (S160), the audio signal is displayed as a text on the display 410 (S161).

However, if the controller determines that the audio signal is stored not in the text format but in the audio compression format, the audio signal is converted from the audio compression format into the text format (S163). That is, the controller 340 inputs the audio signal stored in the audio compression format at the storage unit 330 to the audio-text conversion unit 345 in order to convert the audio signal of the audio compression format into the text type.

Then, the audio signal converted into the text type is played by being displayed on the display 410 (S161).

As shown in FIG. 6, an audio signal stored in an audio compression format is decompressed and played through the audio output unit 420 (path \textcircled{5}), or the audio signal stored in a text format is displayed on the display 410 (path \textcircled{6}). The audio signal stored in the text format is input to the text-audio conversion unit 360 (path \textcircled{7}) and converted into the audio type to be played through the audio output unit 420 (path \textcircled{7}′). Also, the audio signal stored in the audio format is input to the audio-text conversion unit 345 (path \textcircled{8}) and converted into the text type to be displayed on the display 410 (path \textcircled{8}′).

Components to decompress the audio compression format and an image compression format are not illustrated in the drawings, but may be provided in the audio output unit 420, the display 410 or the storage unit 330.

Alternatively, if a command to store a data file is input, the controller 340 may store the data file in a default format. The default format may be set up when the image communication apparatus is manufactured or by the user. Here, the user may set up and change the default format using user interface information via the user input unit 230. For example, an audio compression format is set up as a default format for a visually handicapped user.

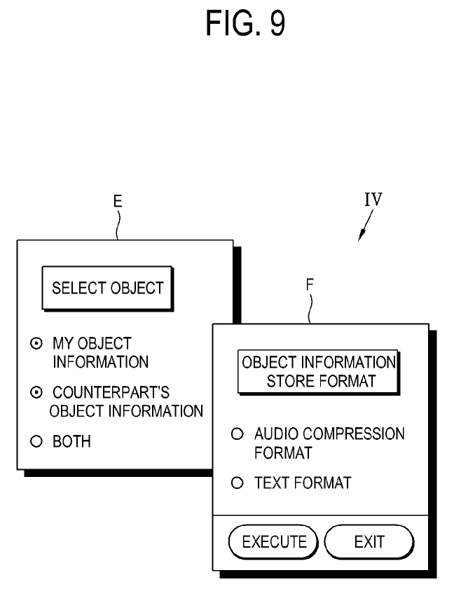

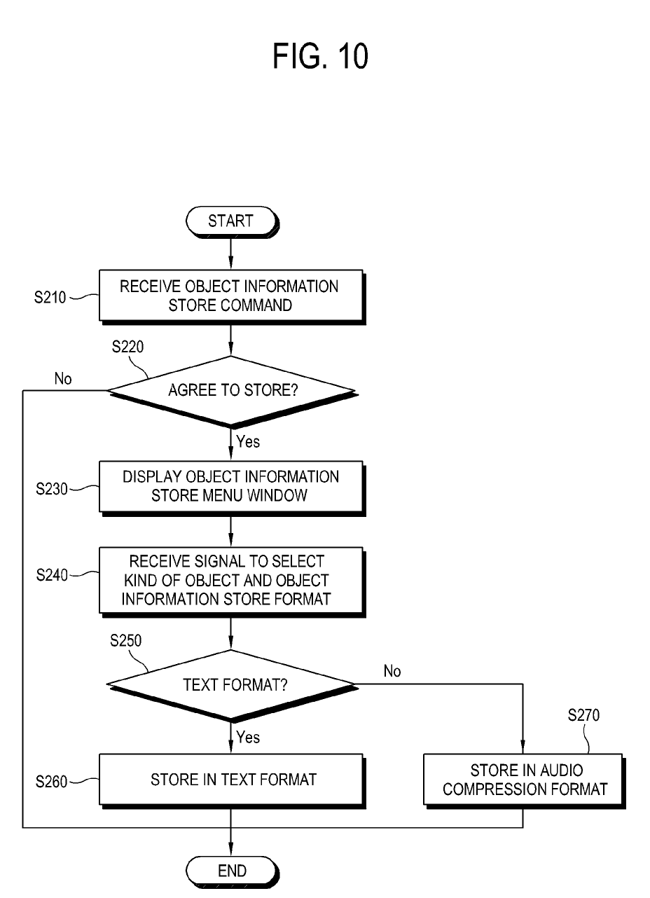

FIG. 9 illustrates a menu window (IV) for storing information on an object in an image communication apparatus according to a third exemplary embodiment of the present invention; and FIG. 10 is a flow chart to illustrate a method of storing information on an object in the image communication apparatus according to the third exemplary embodiment of the present invention.

The image communication apparatus according to the present exemplary embodiment generates information on a picked up object using an encoder 310 which encodes an image signal and stores information on the object received through a communication unit 500. The information on the object refers to the number of the object, information on entrance and exit of an object, etc. and is a part of data stored in an image compression format.

The encoder 310 generates information on the object, i.e., a user who is picked up by an image picking up unit 220, and encodes the information using an algorithm to compress moving pictures, e.g., MPEG-4. Namely, the encoder 310 detects the number of people involved in communications or who enters or exits through an image which is picked up by the image pickup unit 220 using an object algorithm of a moving picture codec and encodes an image signal related to the information.

Here, if a camera with high resolution is used, only a part of the picked up image may be cropped. In this case, a cropped part may be moved along a motion of the object. That is, the cropped part is moved so that the object is always positioned in the center of a screen.

A decoder 320 decodes the information on the object input through the communication unit 500, and a controller 340 stores the information on the object in an audio compression format or a text format.

If a command to store the information on the object is received through a user input unit 230 (S210) and a command of a user and a counterpart agreed on storing the information corresponding to a control signal asking for the agreement is received (S220), the controller 340 displays a menu window (IV) of storing the object information on the display 410 (S230), as shown in FIG. 9. The menu window (IV) includes a fifth menu window (E) to select a kind of object information and a sixth menu window (F) to select a format for storing the object information.

Then, the controller 340 receives a signal of the selected kind of object to be stored and the storing format (S240), and determines whether the storing format is the text format (S250).

If the storing format is determined to be the text format, the information on the object is stored in the text format (S260). If the storing format is determined to be not the text format but the audio compression format, the information on the object is stored in the audio compression format (S270).

If the information on the object is stored, capacity of a storage unit and load to process a moving picture may be improved as compared with when image communications are all stored as a moving picture.

The user may store information on an object only, an audio signal only or both of them depending on a capacity of the storage unit 330. Also, the user may store an image signal excluding or including an audio part as a moving picture.

Thus, a user interface generating unit 350 generates a menu window where a plurality of storing formats may be selected corresponding the respective cases.

The stored information on the object is played in a similar method to the method illustrated in FIGS. 6 to 8, and the user may hear the information on the object in the audio type or see it in the text type.

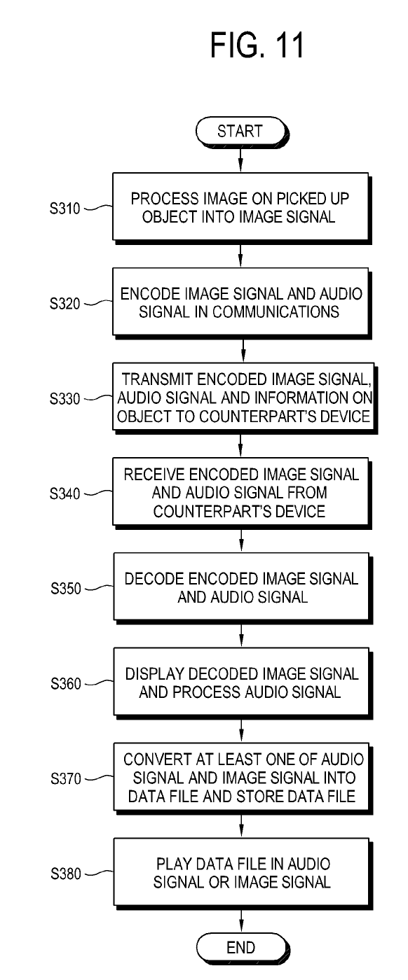

FIG. 11 is a flow chart to illustrate a control method of the image communication apparatus according to the present invention. Referring to FIG. 11, the overall control method of the image communication apparatus is summarized as follows. An image signal of an object which is picked up is processed (S310).

Then, the processed image signal and an audio signal of the object in communications are encoded, and information on the object is generated as necessary (S320). Here, the image signal is encoded using an algorithm to compress moving pictures, e.g., MPEG-4.

If the image signal and the audio signal are completely encoded, the encoded signals are transmitted to a counterpart's device (S330). Here, if the user determines that the object (sender) is absent on a screen through a camera, transmitting the image signal may be stopped. Namely, a transmitting part analyzes an image before the image is transmitted. If no object in motion is caught on a screen, it is considered that the image is meaningless for the counterpart, thereby stopping transmitting the image. Thus, meaningless images are not transmitted and received. A receiving part watches the last image in a still screen, and may resume transmitting and receiving an image again if a moving object appears.

However, the foregoing description is illustrated as an example for an exemplary embodiment. If an image is not transmitted, the image photographed by a camera adapted in the display apparatus of the present invention is displayed at the same time. Here, the image photographed by the camera may be encoded and decoded to be displayed on the display apparatus, and a motion of the object in the image may be detected.

If the encoded image signal of the image is completely transmitted, encoded image and audio signals are received from the counterpart's device (S340). Then, the received audio and image signals are decoded (S350) and output (S360).

If a control signal to store the audio and image signals is input, at least one of the signals is converted into a data file and the data file is stored (S370).

If a command to play the audio or image signal is input, the stored data file is played in an audio or image signal to be output (S380). Here, the audio signal is played in an audio type or a text type, and an image signal is played as a moving picture or information on an object.

As described above, the exemplary embodiments of the present invention provide an image communication apparatus which is capable of storing contents of communications as various kinds of formats and a control method of the same.

In detail, the exemplary embodiments of the present invention provide an image communication apparatus which is capable of storing contents of communications as a audio format, a test format or an image format and a control method of the same.

Further, the exemplary embodiments of present invention provide an image communication apparatus which is capable of storing information on motion of an object as well as contents of communications as an audio format or a text format and a control method of the same.

Also, the exemplary embodiments of the present invention provide an image communication apparatus which provides various kinds of user interfaces so that a user may select a format to store contents of communications and a control method of the same.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. An image communication apparatus comprising:
an image pickup unit which picks up a user image of a user and processes the user image into a user image signal;
an audio input unit which receives a user audio signal of the user;
an encoder which encodes the user image signal processed by the image pickup unit and the user audio signal;
a communication unit which receives an image signal and an audio signal from an external device and transmits the user image signal and the user audio signal which are encoded by the encoder;
a controller which converts at least one of the user audio signal, the user image signal, the received image signal and the received audio signal into a data file and stores the data file.

2. The image communication apparatus according to claim 1, wherein the controller encodes at least one of the user audio signal, the user image signal, the received image signal and the audio signal as the data file.

3. The image communication apparatus according to claim 2, further comprising:
a display;
a user input unit which selects a function of storing data; and
a user interface generating unit which generates user interface information to be displayed on the display,
wherein the controller controls the user interface generating unit to display a first menu window, where a data format to store the data file is selected, on the display if the function of storing the data is selected through the user input unit.

4. The image communication apparatus according to claim 3, wherein the data format comprises at least one of an audio compression format, an image compression format and a text format.

5. The image communication apparatus according to claim 4, wherein the first menu window comprises an item to select at least one of the audio compression format, the image compression format and the text format as the data format.

6. The image communication apparatus according to claim 5, wherein the controller comprises an audio-text conversion unit which converts at least one of the user audio signal and the received audio signal into the text format.

7. The image communication apparatus according to claim 6, further comprising a text-audio conversion unit which converts the text format into an audio signal.

8. The image communication apparatus according to claim 7, further comprising an audio output unit which outputs the user audio signal and the received audio signal.

9. The image communication apparatus according to claim 8, wherein the controller controls the user interface generating unit to display a second menu window which comprises an item to select a play type of playing the data file on the display if a command to play the data file is input through the user input unit, and controls the text-audio conversion unit to output the data file to one of the audio output unit and the display according to the play type of playing the data file.

10. A control method of an image communication apparatus, the control method comprising:
processing a user image of a user which is picked up, into a user image signal;
encoding the processed user image signal and a user audio signal of the user;
transmitting the encoded user image signal and the encoded user audio signal;
receiving an image signal and an audio signal; and
performing a data storage operation which comprises converting at least one of the user image signal, the user audio signal, the received image signal and the received audio signal into a data file and storing the data file.

11. The control method according to claim 10, wherein converting comprises encoding at least one of the user audio signal, the user image signal, the received image signal and the audio signal.

12. The control method according to claim 11, further comprising:
receiving a selection signal to select the data storage function; and
generating and displaying a first menu window where a data format to store the data file is selected.

13. The control method according to claim 12, wherein the first menu window comprises an item to select at least one of an audio compression format, an image compression format and a text format as the data format.

14. The control method according to claim 13, wherein the performing the data storage operation comprises converting the user audio signal and the received audio signal into the text format if the text format is selected.

15. The control method according to claim 13, further comprising:
receiving a command to play the data file;
generating and displaying a second menu window which comprises an item to select a play type of playing the data file; and
playing the data file in at least one of an audio signal and an image signal according to the play type of the playing the data file.

16. The control method according to claim 15, wherein the second menu window comprises an item to select at least one of an audio type, an image type and the text type as the play type of the playing.

17. The control method according to claim 16, the playing comprises converting the data file stored in the text format into an audio signal if the audio type is selected.

18. The image communication apparatus according to claim 1, further comprising a storage unit which stores the data file.
